(19) United States
(12) Patent Application Publication
(10) Pub. No.: US 2017/0116001 A1
(43) Pub. Date: Apr. 27, 2017

(54) GENERATING USER ASSISTANCE

(71) Applicant: Hewlett-Packard Enterprise Development LP, Houston, TX (US)

(72) Inventors: Veronique Levy, Yehud (IL); Ya-Bin Zhou, Shanghai (CN); Idan Liron-Livne, Yehud (IL)

(21) Appl. No.: 14/919,209

(22) Filed: Oct. 21, 2015

(51) Int. Cl. G06F 9/44; G06F 17/21; G06F 17/22

(52) U.S. Cl. CPC G06F 9/4446; G06F 17/2235; G06F 17/2247; G06F 17/211

(57) ABSTRACT

Example implementations relate to generating user assistance. For example, a system for generating user assistance may include a build master engine to generate a development file for an application specific item, wherein the development file includes a unique name corresponding to the application specific item. Similarly the system may include a document generation engine to receive the development file from the build master engine and generate a reusable application file for the application specific item based on the development file. Moreover, the system may include a user assistance engine to cause the generation of a user assistance message that includes information from the reusable application file, wherein the user assistance message corresponds to the application specific item.

### BACKGROUND

Various tools may be utilized when building and deploying applications in a computing network. Such tools may assist an administrator configure the application, and may in part, automate the build and/or deployment process. Such tools may also assist an end-user with using the application. Information may supplement the tool, and may aid the administrator and/or end-user in accurately configuring the application, understanding the processes executed by the tool, and/or using the application correctly.

### BRIEF DESCRIPTION OF THE DRAWINGS

FIG. 1 is a block diagram of an example system for generating user assistance consistent with the present disclosure.

FIG. 2 is a block diagram of an example system for generating user assistance, consistent with the present disclosure.

FIG. 3 illustrates an example application page including an example user assistance message, consistent with the present disclosure.

FIG. 4 illustrates an example portion of an example application page, consistent with the present disclosure.

FIG. 5 illustrates an example portion of an example support document, an example reusable application file, and an example directory of reusable application files, consistent with the present disclosure.

FIG. 6 illustrates an example method for generating user assistance consistent with the present disclosure.

### DETAILED DESCRIPTION

Network administrators may invest tremendous amounts of time in configuring and installing applications. As used herein, an application may refer to computer-readable instructions configured to permit a user to perform a group of coordinated operations, tasks, and/or activities. In the same way, end-users may invest tremendous amounts of time in using applications. As used herein, an application may refer to computer-readable instructions configured to permit a user to perform a group of coordinated operations, tasks, and/or activities.

Various tools may be used to simplify and automate the process of building and deploying applications, or using applications, in a computing network. As used herein, a tool that may be used to build and/or deploy an application is referred to as a build master. A build master may utilize a plurality of application pages that walk an administrator and/or end-user through the process of building and/or deploying the application. Put another way, an application page may refer to a user interface page displayed during installation of the application. Examples are not so limited, however, and an application page may refer to a page displayed during use of the application, as discussed herein. Each application page may include a plurality of places where the administrator and/or end-user may perform some action and/or enter information.

Depending on the skill level of the administrator and/or end-user, questions may arise as to how to accurately input information and/or select options on each application page during installation and/or usage of an application. While helpful, a help document that includes a large amount of user assistance information for the installation and/or usage of the application may be overwhelming and may include a huge amount of information per page. In order to find information related to a specific topic, an administrator and/or eng-user may need to scan the entire help document to find information pertinent to a specific question.

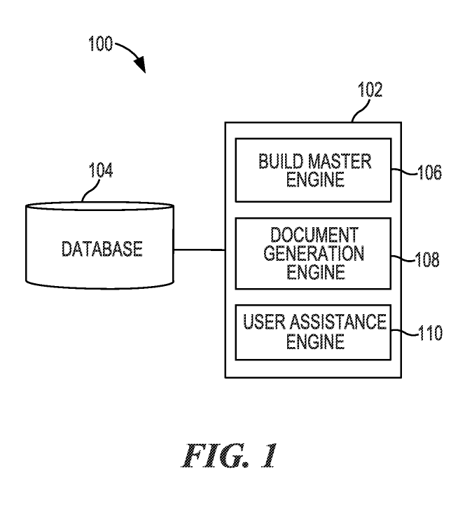

Generating user assistance consistent with the present disclosure allows for display of user assistance information near an application specific item to assist administrators and/or end-users during the installation and/or usage of applications. As used herein, an application specific item refers to an item displayed on an application interface that includes features specific to the application. By linking user assistance messages to icons near each application specific item, a considerable reduction in the manual work of the administrator and/or end-user may be realized. User assistance messages consistent with the present disclosure may provide accurate and correct information on the spot. Similarly, generating user assistance consistent with the present disclosure may allow for the information that is displayed in user assistance messages to include all of the information relating to the application specific item as it appears in support documentation for the application, as discussed in relation to FIG. 1. As used herein, a user assistance message refers to a message displayed on a user interface including additional information relating to a particular application specific item. A user assistance message may include default values, an explanation of limitations of entry, and/or any other information that may be relevant to the particular application specific item.

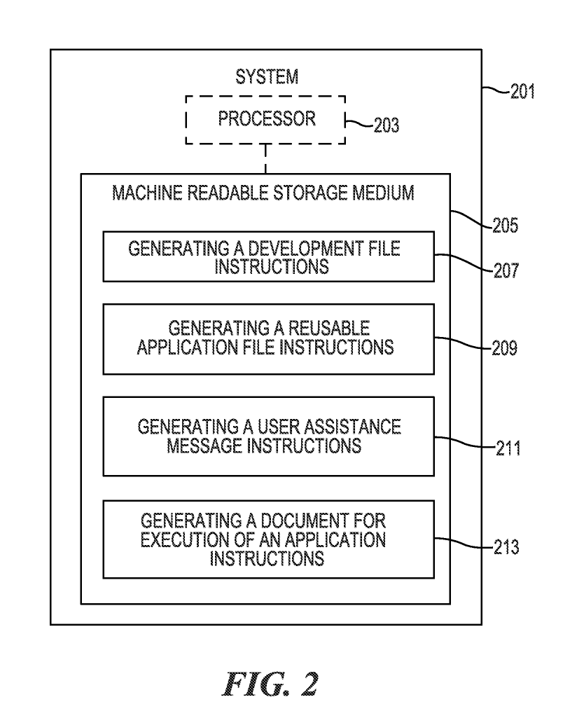

FIG. 1 is a block diagram of an example system 100 for generating user assistance consistent with the present disclosure. The system 100 may include a database 104, a user assistance generation system 102, and/or a number of engines (e.g., build master engine 106, document generation engine 108, and user assistance engine 110). The user assistance generation system 102 may be in communication with the database 104 via a communication link, and may include the number of engines (e.g., build master engine 106, document generation engine 108, and user assistance engine 110). The user assistance generation system 102 may include additional or fewer engines than illustrated to perform the various operations as will be described in further detail in connection with FIGS. 2-6.

The number of engines (e.g., build master engine 106, document generation engine 108, user assistance engine 110) may include a combination of hardware and programming, but at least hardware, that is configured to perform operations described herein (e.g., generate a development file for an application specific item, generate a reusable application file for the application specific item, generate a user assistance message, etc.) stored in a memory resource (e.g., computer-readable medium, machine-readable medium, etc.) as well as hard-wired program (e.g., logic).

The build master engine 106 may include hardware and/or a combination of hardware and programming, but at least hardware, to generate a development file for an application specific item, wherein the development file includes a unique name corresponding to the application specific item. For instance, if the application were a business performance management application, the application specific items displayed on the application interface may be specific to the business performance management application. As used herein, a development file may refer to a file that is used in the development of an application page. The development file may include information relevant for displaying content on the application page and/or linking information on the application page. In some examples, the development file may be in a hypertext markup (HTM) format, though examples are not so filed. For example, the build master engine 106 may generate a HTM file for an application specific item, such as a field on the user interface, and use the HTM file in generating the application page for the application. The HTM file, in this example, may include a unique name, as described herein.

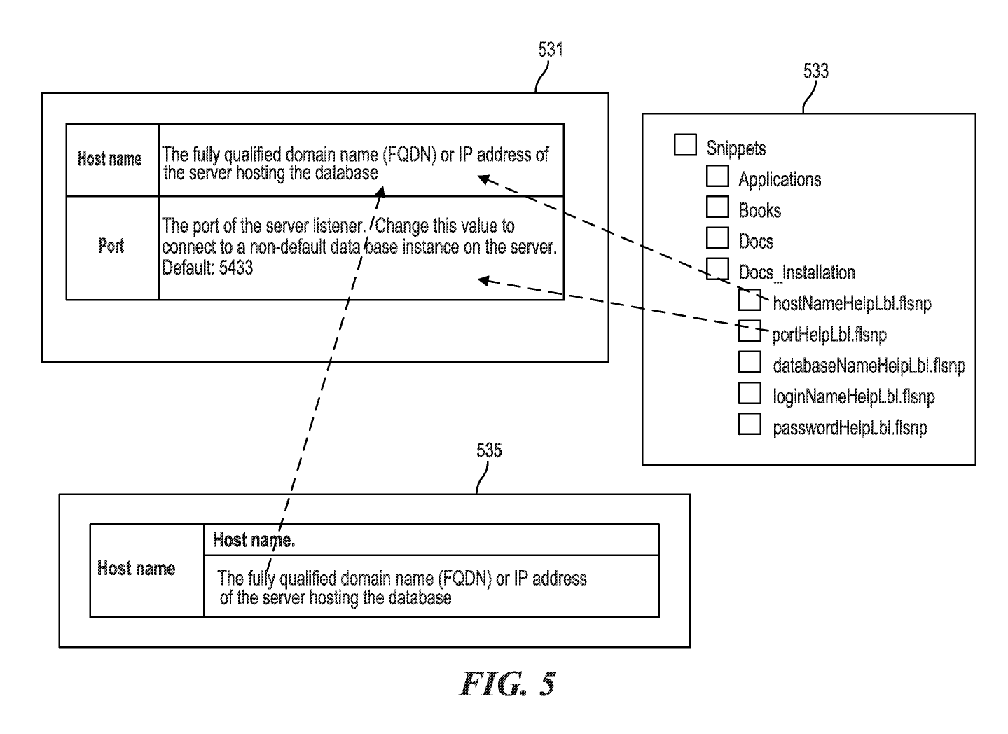

The build master engine 106 may assign a unique name corresponding to the application specific item to the HTM file. For example, if the application specific item is a field that is labeled “host name”, the unique name for the HTM file associated with the “host name” field may be “hostNameHelpLbl”, such that the unique name may be linked to the “host name” field. Also, as discussed further in relation to FIG. 5, the build master engine 106 may store the generated HTM file in an HTM directory selected by the build master. In such a manner, a build master may access the directory and select and reuse various HTM files for generating application pages in an expeditious manner.

The document generation engine 108 may include hardware and/or a combination of hardware and programming, but at least hardware, to receive a development file from the build master engine 106 and generate a reusable application file for the application specific item based on the development file. As used herein, a reusable application file refers to a file that may be used to interpret and compose text, images and other material into visual and/or audible applications. Also as used herein, a reusable application file may refer to a reusable file used during installation of the application as well as usage of the application. Again, if the application specific item was a “host name” field, the document generation engine 108 may receive the HTM file associated with the “host name” field, and generate a reusable application file based on the HTM file received. Examples of a reusable application file may include hypertext markup language (HTML) files, and/or snippets. As used herein, a snippet refers to a small HTML file that may be reused and includes the suffix .FLSNP. While HTML files and snippets are provided as examples of reusable application files, examples are not so limited and reusable application files may be in other formats.

The document generation engine 108 may receive a unique name, and generate a snippet (e.g., reusable application file) named with the unique name. For example, the document generation engine 108 may receive an HTM file from the build master engine 106 for a “host name” field in an application, where the name of the HTM file is the unique name hostNameHelpLbl. The document generation engine 108 may generate a snippet for the “host name” field, and the snippet may include the unique name corresponding to the “host name” field, i.e., the snippet's name may include hostNameHelpLbl as a prefix of the .FLSNP file. As such, the document generation engine 108 may generate the reusable HTML file (e.g., the snippet) using the unique name of the application specific item.

Additionally, the document generation engine 108 may generate a support document for execution of the application, wherein the generated document includes the reusable HTML file. For example, the document generation engine 108 may generate a support document used for designing, installing, and/or using the application. In some examples, the build master engine 106 may store the generated support document in a build master directory for retrieval and/or update, as needed.

In some examples, the document generation engine 108 may generate a user assistance icon associated with the application specific item that is linked to the user assistance message. The icon may be a recognizable icon that signifies to a user an association with a user assistance message. Examples of a user assistance icon may include a question mark, a help button, and/or other types of user assistance icons.

The user assistance engine 110 may include hardware and/or a combination of hardware and programming, but at least hardware, to cause the generation of a user assistance message that includes information from the reusable application file, where the user assistance message corresponds to the application specific item. For example, the user assistance engine 110 may generate, responsive to receipt of the reusable HTML file from the document generation engine 106, a user assistance message that includes information from the reusable HTML file (e.g. the reusable application file).

FIG. 2 is a block diagram of an example system 201 for generating user assistance, consistent with the present disclosure. System 201 may include a computing device that is capable of communicating with a remote system. In the example of FIG. 2, system 201 includes a processor 203 and a machine-readable storage medium 205. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 203 may be a central processing unit (CPU), microprocessor, and/or other hardware device suitable for retrieval and execution of instructions stored in machine-readable storage medium 205. In the particular example shown in FIG. 2, processor 203 may receive, determine, and send instructions 207, 209, 211, 213 for generating user assistance. As an alternative or in addition to retrieving and executing instructions, processor 203 may include an electronic circuit comprising a number of electronic components for performing the operations of the instructions in machine-readable storage medium 205. With respect to the executable instruction representations (e.g., boxes) described and shown herein, it should be understood that part or all of the executable instructions and/or electronic circuits included within one box may be included in a different box shown in the figures or in a different box not shown.

Machine-readable storage medium 205 may be any electronic, magnetic, optical, or other physical storage device that stores executable instructions. Thus, machine-readable storage medium 205 may be, for example, Random Access Memory (RAM), an Electrically-Erasable Programmable Read-Only Memory (EEPROM), a storage drive, an optical disc, and the like. Machine-readable storage medium 205 may be disposed within system 201, as shown in FIG. 2. In this situation, the executable instructions may be “installed” on the system 201. Machine-readable storage medium 205 may be a portable, external or remote storage medium, for example, that allows system 201 to download the instructions from the portable/external/remote storage medium. In this situation, the executable instructions may be part of an “installation package”. As described herein, machine-readable storage medium 205 may be encoded with executable instructions for monitoring network utilization.

Referring to FIG. 2, generating a development file instructions 207, when executed by a processor (e.g., 203), may cause system 201 to cause the generation of, for each of a plurality of application specific items in an application displayed on a user interface, a development file based on a unique name corresponding to a respective one of the plurality of application specific items. Put another way, generating a development file instructions 207 may cause the system 201 to generate an HTM file, or other format of development file, for each application specific item in an application page.

Generating a reusable application file instructions 209, when executed by a processor (e.g., 203), may cause system 201 to cause the generation of, for each of a plurality of application specific items in an application displayed on a user interface, a reusable application file based on the development file. As described in relation to FIG. 1, the reusable application file may include the unique name corresponding to the particular application specific item. The instructions to generate the reusable application file may include instructions to designate the unique name as a prefix of the reusable application file. For instance, if the unique name associated with the application specific item is hostNameHelpLbl, the name of the reusable application file may be hostNameHelpLbl.FLSNP.

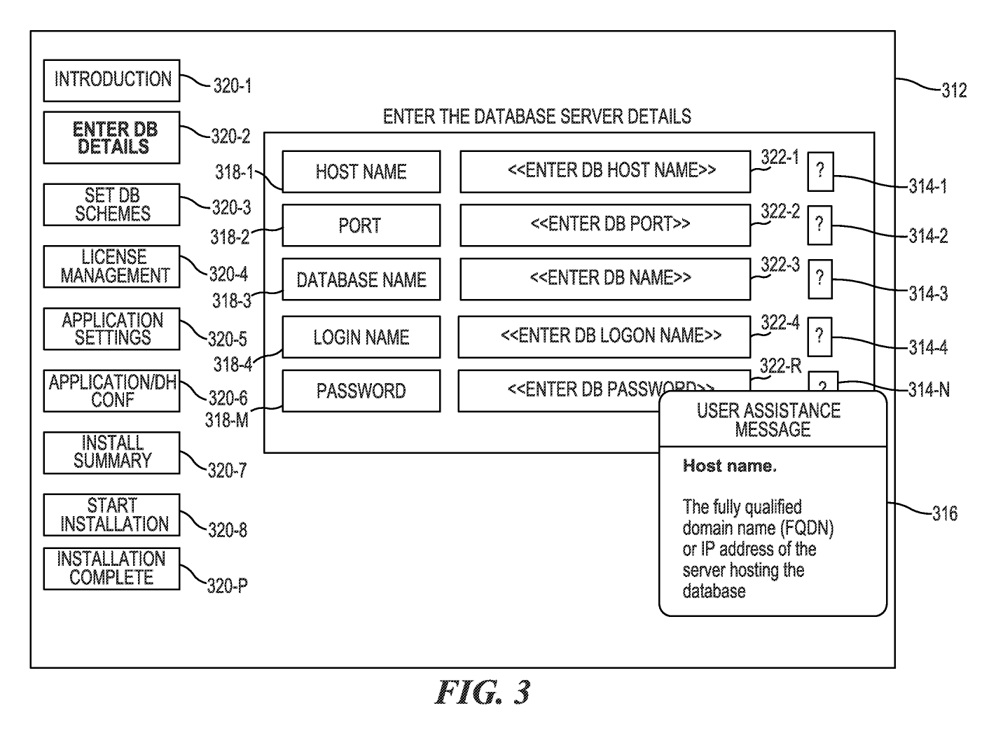

Generating a user assistance message instructions 211, when executed by a processor (e.g., 203), may cause system 201 to cause the generation of, for each of a plurality of application specific items in an application displayed on a user interface, a user assistance message that includes information from the reusable application file. As discussed further in relation to FIGS. 3-5, a user assistance message may be generated for each application specific item displayed on the interface of the application page. Notably, the application page may only include one application specific item, in which case only one user assistance message may be generated. However, examples are not so limited, and the application page may include a plurality of application specific items, and a plurality of user assistance messages may be generated.

Generating a document for execution of an application instructions 213, when executed by a processor (e.g., 203), may cause system 201 to cause the generation of a support document for installation and/or usage of the application including the plurality of reusable application files. For example, as discussed in relation to FIG. 1, a document (e.g., a support document) may be generated that assists with the installation and/or use of the application. As described in FIG. 1, the document generation engine 108 may generate a support document for installation and/or use of the application. The support document may be a technical documentation for online help, software documentation, policy & procedure manuals, knowledge bases and/or user guides.

In some examples, the system 201 may further include instructions executable by the processor 203 to incorporate the plurality of user assistance messages into the support document. As discussed further in relation to FIG. 5, the content of each user assistance message may be combined into the support document, resulting in a comprehensive support document for the entire application. That is, the support document may be used during installation and usage of the application. In some examples, the instructions executable by the processor to incorporate the plurality of user assistance messages may include instructions to link text from the support document to the user assistance messages displayed on the user interface. In such a manner, if the support document is updated, so too are the user assistance messages displayed on the user interface.

In some examples, the system 201 may further include instructions executable by the processor 203 to cause the processor 203 to convert each of the plurality of reusable application files back to a development file format for reuse by the processor in generating revised application files. For instance, if each development file were in an HTM file format, and each reusable application file were in a FLSNP format, then the reusable application file may be converted back to an HTM format for storage and retrieval in generating revised application files. As described herein, a revised application file refers to a revised file, such as a revised installation file, used during installation and/or usage of the application.

FIG. 3 illustrates an example application page 312 including an example user assistance message 316, consistent with the present disclosure. As described herein, an application page may assist an administrator with building and/or deploying an application. The application page 312 may include a plurality of application specific items. For instance, the application page 312 may include a plurality of fields 318-1, 318-2, 318-3, 318-4, 318-M (collectively referred to herein as fields 318). Each field may define some portion of the application to be built. The application page 312 may further include field headers 320-1, 320-2, 320-3, . . . , 320-P (collectively referred to herein as field headers 320). Each field header 320 may include a plurality of fields 318 which may assist an administrator in building and/or deploying an application. The same principle may be used for end-user application pages, as well as pages displayed during installation of the application, e.g. user interfaces for use of an application may include a plurality of fields.

For example, field headers 320 for a particular application page 312 may include “enter db details” 320-2, which allows an administrator to define details pertaining to a database server. Similarly, field headers 320 for the application page 312 may include “application settings” 320-5, which allows the administrator to define settings pertaining to the application. As illustrated in FIG. 3, examples of fields may include host name 318-1, port 318-2, database name 318-3, login name 318-4, and password 318-M. While “host name”, “port”, “database name”, “login name”, and “password” are provided herein as examples of fields on application page 312, examples are not so limited, and other fields not listed herein may be provided. Again, the same principle may be applied for end-user application pages as well as pages displayed during installation of the application.

As illustrated in FIG. 3, each field may have a text box 322-1, 322-2, 322-3, 322-4, 322-R that allows an administrator to enter text relevant to the related field. For instance, a user may enter a database host name in text box 322-1 to define field 318-1, e.g., the host name for the application being built. Also, a user assistance icon 314-1, 314-2, . . . , 314-N may be displayed near each application specific item, which signifies that a user assistance message is available for that particular application specific item. While FIG. 3 illustrates a user assistance icon adjacent to each text box, it should be noted that user assistance icons may be displayed near any application specific item. For instance, if application page 312 included radio buttons, user assistance icons could be displayed near the radio buttons to signify the existence of user assistance messages for the particular radio button. Similarly, if application page 312 included toggles and/or dropdown buttons, a user assistance icon could be displayed near each of those application specific items to signify the existence of user assistance messages for that particular application specific item. Again, the same principle may be applied to end-user application pages, as well as pages displayed during installation of the application.

As illustrated in FIG. 3, a user assistance message 316 may be generated for a particular application specific item. For example, user assistance message 316 provides information pertaining to the “host name” field 318-1. An administrator may have questions regarding what to enter in the text box 322-1, and may click and/or select the user assistance icon 314-1 for more information. In response to the administrator clicking on the user assistance icon 314-1, user assistance message 316 may display. The user assistance message 316 may explain that the host name is “the fully qualified domain name (FQDN) or IP address of the server hosting the database”. As described herein, the user assistance message 316 may include default values, an explanation of limitations of entry, and/or any other information that may be relevant to the particular application specific item. Also, as discussed further in relation to FIG. 5, the user assistance message 316 may include all of the information relating to the application specific item as it appears in the application support documentation. The same principle may be applied to end-user application pages as well as pages displayed during installation of the application.

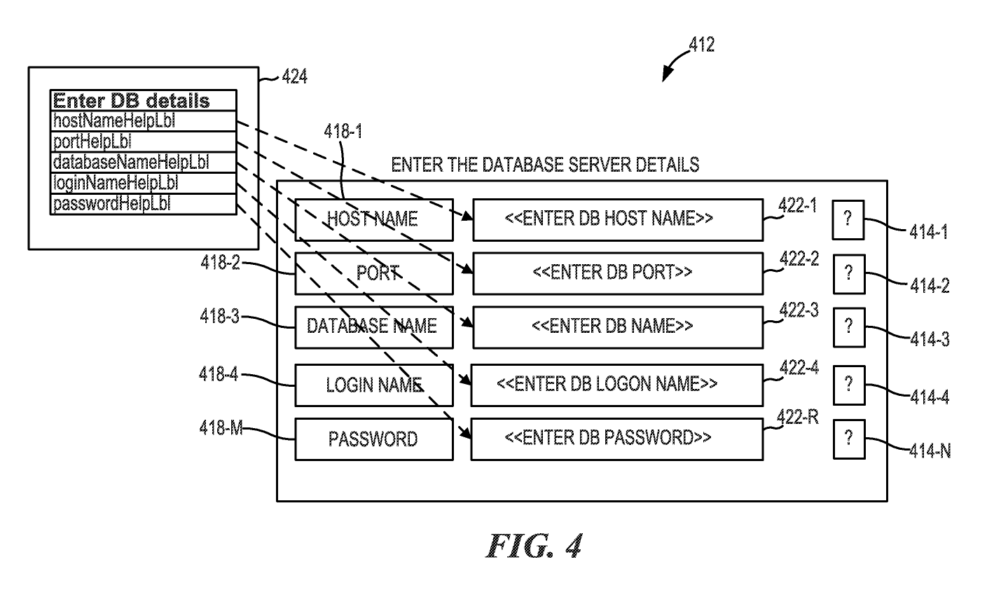

FIG. 4 illustrates an example portion of an example application page 412, consistent with the present disclosure. It should be noted that application page 412 corresponds to application page 312 illustrated in FIG. 3, although application page 412 is illustrated in a simplified form for the ease of discussion. Again, the same principle may be applied to end-user application pages as well as pages displayed during installation of the application.

As described in relation to FIGS. 1 and 2, a unique name may be assigned to each application specific item, and the unique name may be used when generating development files and application files. For example, if application page 412 includes fields 418, and text boxes 422, a unique name may be generated for each of the fields 418 and/or text boxes 422. Examples of unique names are displayed in box 424. For instance, the unique name associated with the “host name” field 418-1 and/or text box 422-1 may be “hostNameHelpLbl”. Similarly, the unique name associated with the “port” field 418-2 and/or text box 422-2 may be “portHelpLbl”. In such a manner, each application specific item in the application page 412 may have a unique name. The unique name may be used to associate a particular development file with a particular application specific item, e.g., associate a hostNameHelpLbl.HTM file with the host name field 418-1 and/or the text box 422-1. Similarly the unique name may be used to generate an application file for generation of a user assistance message and for generating a document for installation and/or usage of the application. For example, the hostNameHelpLbl.HTM development file may be used to generate a HTML file and/or snippet, such as hostNameHelpLbl.FLSNP. The hostNameHelpLbl.FLSNP file is a user assistance message, and may be used to generate documentation for the installation and/or usage of the application, as discussed in FIG. 5. Once the development file, e.g., hostNameHelpLbl.FLSNP, is used for generation of user assistance and/or the installation documentation, the development file may again be converted back to a development file format, such as .HTM, and stored in a relevant directory for future retrieval. The same principle may be applied to end-user application pages as well as pages displayed during installation of the application.

FIG. 5 illustrates an example portion of an example support document 531, an example portion of an example reusable application file 535, and an example portion of an example directory 533 of reusable application files, consistent with the present disclosure. As described in relation to FIGS. 1-4, each application specific item may have a unique name which links development files and/or reusable application files to the particular application specific item. Again, the same principle may be applied to end-user application pages as well as pages displayed during installation of the application.

As illustrated in FIG. 5, a directory 533 may include a plurality of reusable application files. For instance, directory 533 may include a list of snippets that are used for the installation and/or usage of a particular application, the snippets including “hostNameHelpLbl.flsnp”, “portHelpLbl.flsnp”, “databaseNameHelpLbl.flsnp”, “loginNameHelpLbl.flsnp”, and “passwordHelpLbl.flsnp”, among others. Each of the reusable application files, e.g., snippets, may be linked to a portion of text within a support document for installation and/or usage of the application. As described herein, a support document may be a technical documentation for online help, software documentation, policy & procedure manuals, knowledge bases and/or user guides. Therefore, the snippet “hostNameHelpLbl.flsnp” may be linked to the “host name” section of the support document 531. Similarly, the snippet “portHelpLbl.flsnp” may be linked to the “port” section of the support document 531. The same principle may be applied to end-user application pages as well as pages displayed during installation of the application.

Moreover, each reusable application file 535 may be linked to the support document 531, such that content from the reusable application file 535 matches the content from the support document 531. For instance, reusable application file 535, may define the user assistance message for the host name field, as discussed in relation to FIGS. 3 and 4. The reusable application file 535 may include an identification of the application specific item, e.g., “host name”, and may also include text that would be displayed in a user assistance message should an administrator select the associated user assistance icon. For example, the reusable application file 535 may include the text “The fully qualified domain name (FQDN) or IP address of the server hosting the database”, which may display in a user assistance message when prompted. Further, by generating the support document 531 using the reusable application file 535, and also generating user assistance using the same reusable application file 535, the text of the support document 531 may contain identical language to that which is included in the user assistance message for a particular application specific item. Again, the same principle may be applied to end-user application pages as well as pages displayed during installation of the application.

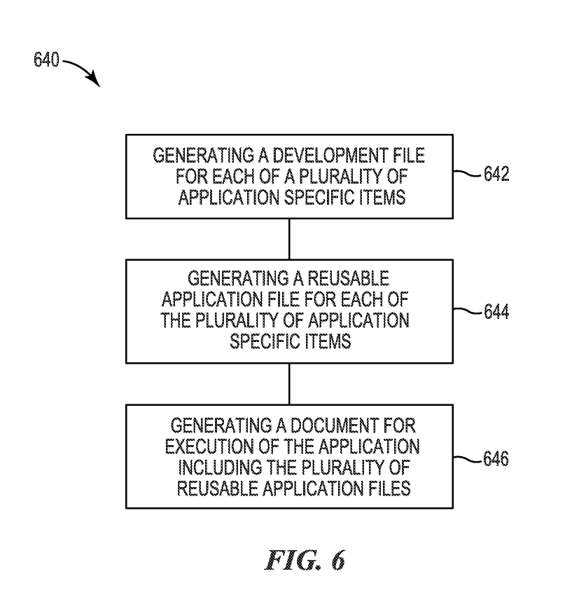

FIG. 6 illustrates an example method 640 for generating user assistance consistent with the present disclosure. At 642, the method 640 may include generating a development file for each of a plurality of application specific items. As described in relation to FIGS. 1-5, the development file may include information relevant for displaying content on an installation and/or application page for an application, and may be used to generate a reusable application file. Each of the plurality of development files may include a unique name corresponding to the respective application specific item.

At 644, the method 640 may include generating a reusable application file for each of the plurality of application specific items. For instance, using a document generation engine, a reusable application file such as a snippet or other HTML file may be generated for each of the plurality of application specific items. The reusable application file may be based on the development file associated with the particular application specific item and may include the unique name.

At 646, the method 640 may include generating a document for execution of the application including the plurality of reusable application files. For example a support document may be generated that includes information pertaining to processes of building, deploying and/or using the application. The support document may include information from the plurality of reusable application files, and each of the plurality of reusable application files may be associated with a respective application specific item, as described herein.

In some examples, the method 640 may include generating user assistance for each of the respective reusable application files, generating the support document by combining the plurality of user assistance messages into a single document, and linking the plurality of user assistance messages to the respective text in the support document. For example, each of the plurality of development files may be in a HTM format and each of the plurality of reusable application files may be in a HTML or FLSNP format. Using the HTML and/or FLSNP files, a support document may be generated which includes help information for all application specific items, and user assistance messages may be generated for each individual application specific item.

In some examples, the method 640 may further include converting each of the plurality of reusable application files back to the format of the development file for storage. For instance, the method may include converting the HTML files back to an HTM format and saving the converted HTM files in a build master directory accessible by a document generation engine, and generating revised application files from the converted HTM files, where the revised application files are in an HTML format.

In the foregoing detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense. As used herein, the designators “N”, “M”, “P”, and “R”, particularly with respect to reference numerals in the drawings, indicate that a number of the particular feature so designated can be included with examples of the present disclosure. The designators can represent the same or different numbers of the particular features. Further, as used herein, “a number of” an element and/or feature can refer to one or more of such elements and/or features.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

What is claimed:

1. A system for generating user assistance, comprising:
a build master engine to generate a development file for an application specific item, wherein the development file includes a unique name corresponding to the application specific item;
a document generation engine to receive the development file from the build master engine and generate a reusable application file for the application specific item based on the development file; and
a user assistance engine to cause the generation of a user assistance message that includes information from the reusable application file, wherein the user assistance message corresponds to the application specific item.

2. The system of claim 1, wherein the reusable application file includes the unique name corresponding to the application specific item.

3. The system of claim 1, wherein the document generation engine generates the reusable application file using the unique name.

4. The system of claim 1, wherein the document generation engine generates a support document for installation of the application using the reusable application file.

5. The system of claim 4, wherein:
the build master engine stores the development file in a build master directory; and
the document generation engine accesses the stored development file for generation of a second reusable application file.

6. The system of claim 1, wherein:
the application specific item is one of a field and a button displayed on a user interface during installation of the application; and
the user assistance message includes information pertaining to configuration of the application specific item during installation of the application.

7. A non-transitory machine-readable medium storing instructions executable by a processor to cause the processor to:
cause the generation of, for each of a plurality of application specific items in an application displayed on a user interface:
a development file based on a unique name corresponding to a respective one of the plurality of application specific items;
a reusable application file based on the development file, wherein the reusable application file has the unique name; and
a user assistance message that includes information from the reusable application file; and
cause the generation of a support document for the application including the plurality of reusable application files.

8. The medium of claim 7, wherein the instructions executable by the processor to cause the generation of the development file includes instructions to designate the unique name as a prefix of the development file.

9. The medium of claim 7, wherein the instructions executable by the processor to cause the generation of the reusable application file includes instructions to designate the unique name as a prefix of the reusable application file.

10. The medium of claim 7, further comprising instructions executable by the processor to cause the processor to:
incorporate the plurality of user assistance messages into the support document.

11. The medium of claim 10, wherein the instructions executable by the processor to incorporate the plurality of user assistance messages includes instructions to link text from the support document to the user assistance messages displayed on the user interface.

12. The medium of claim 9, further comprising instructions executable by the processor to cause the processor to:
convert each of the plurality of reusable application files back to a development file format for reuse by the processor in generating revised application files.

13. A method for generating user assistance, comprising:
generating a development file for each of a plurality of application specific items associated with an application, wherein each of the plurality of development files includes a unique name corresponding to the respective application specific item;
generating a reusable application file for each of the plurality of application specific items based on the development file and including the unique name; and
generating a support document for support of the application including the plurality of reusable application files, wherein each of the plurality of reusable application files is associated with a respective application specific item.

14. The method of claim 13, further comprising:
generating a user assistance message for each of the respective reusable application files;
generating the support document by combining the plurality of user assistance messages into a document; and
linking the plurality of user assistance messages to the respective text in the support document.

15. The method of claim 13, wherein each of the plurality of development files is in a hypertext markup (HTM) format and each of the plurality of reusable application files is in a hypertext markup language (HTML) format, the method further comprising:
converting each of the plurality of HTML files back to an HTM format and saving the converted HTM files in a build master directory accessible by the document generation engine; and
generating revised application files from the converted HTM files, wherein the revised application files are in an HTML format.
